(19) United States
(12) Patent Application Publication
(10) Pub. No.: US 2005/0005708 A1
(43) Pub. Date: Jan. 13, 2005

(54) Electronic volume measuring equipment

(76) Inventor: Guy Dickes, Baltimore, MD (US)

Correspondence Address: GUY DICKES, 6718 CHOKEBERRY RD., BALTIMORE, MD, 21209, US

(21) Appl. No.: 10/614,173

(22) Filed: Jul. 8, 2003

(51) Int. Cl. G01F 1/00

(52) U.S. Cl. 73/861

(57) ABSTRACT

Electronic Volume Measuring Equipment is designed to measure any air tight space, void, container, piping system, or tank utilizing pressurized air, gas or vacuum. It uses electronic gas mass flow technology to achieve accurate results. Added benefits allow for the location of leaks prior to volume measurement.

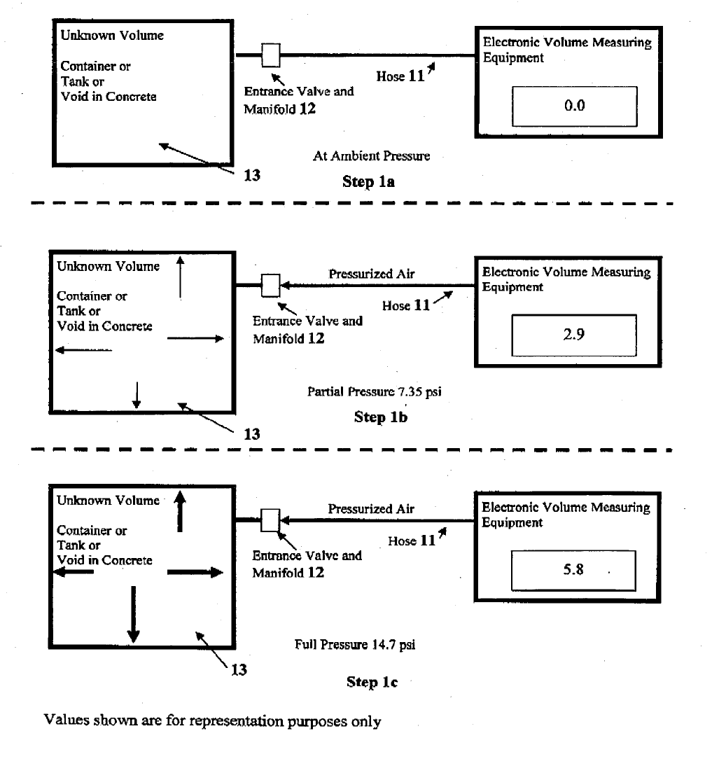

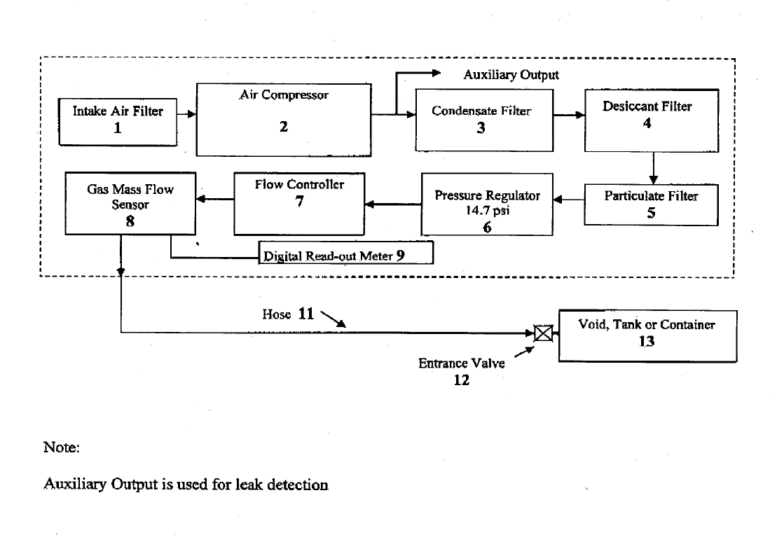

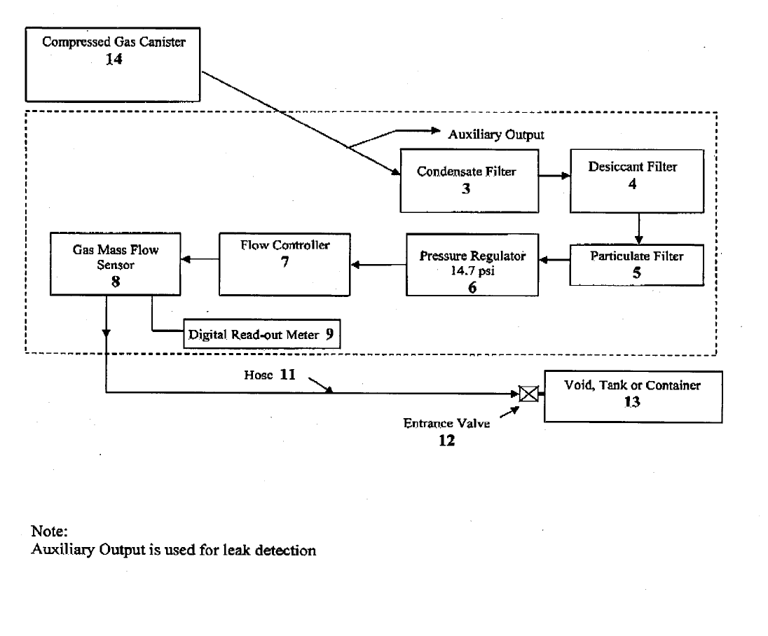

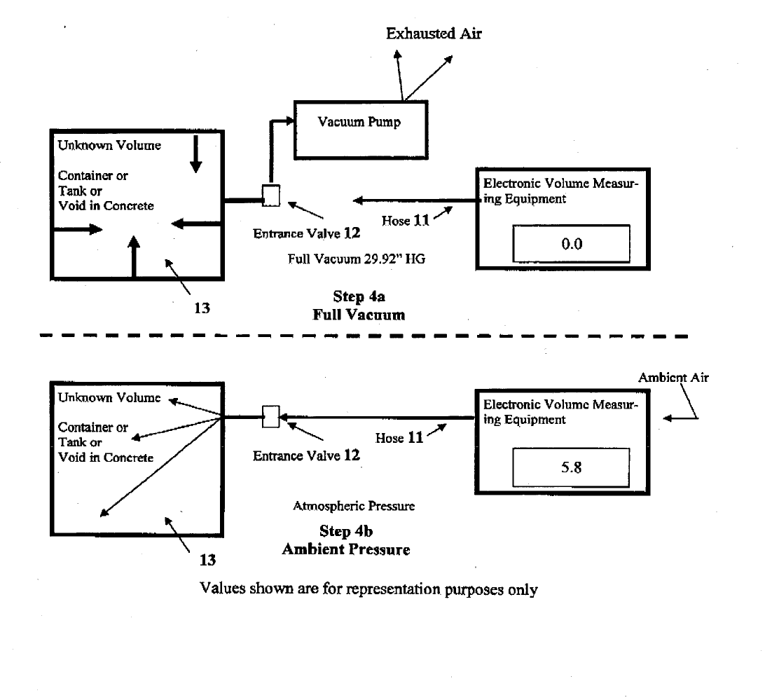

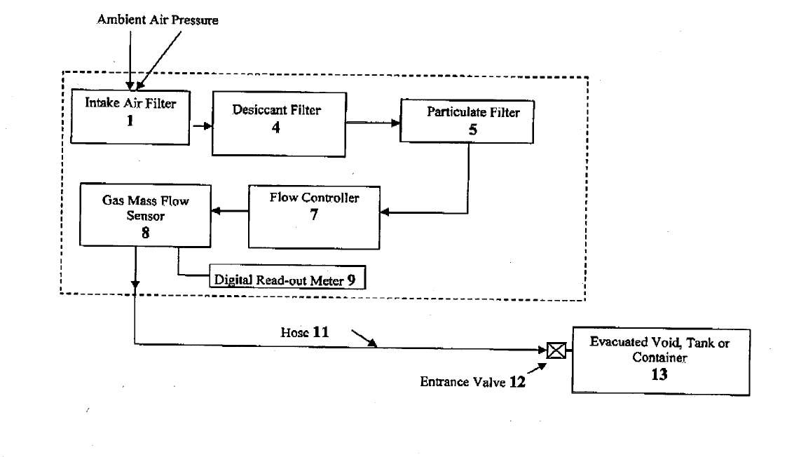

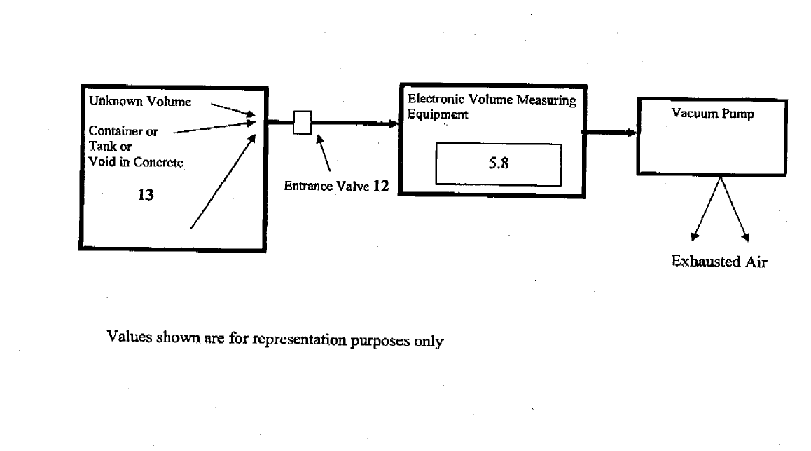

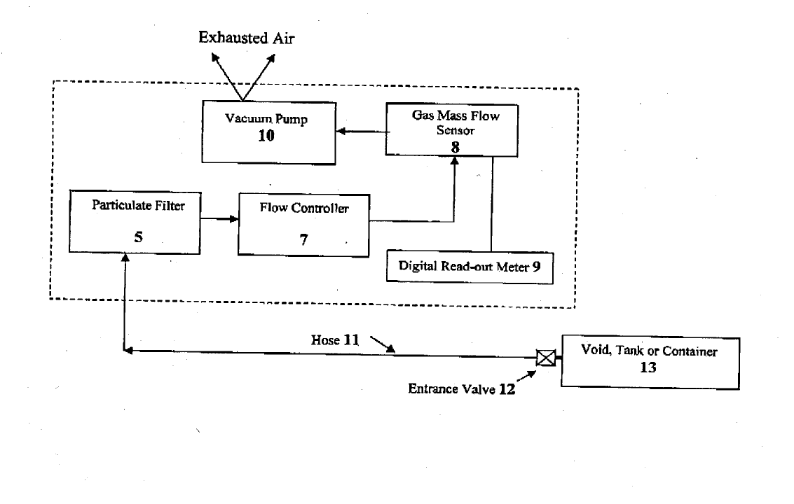

### CROSS REFERENCE to RELATED APPLICATIONS

Not applicable

### STATEMENT REGARDING FEDERALLY SPONSORED RESEARCH or DEVELOPMENT

Not applicable

### REFERENCE TO SEQUENCE LISTING, TABLE, OR COMPUTER LISTING COMPACT DISK

Not applicable

### BACKGROUND OF THE INVENTION

Electronic Volume Measuring Equipment originated in response to the needs of the Post-Tensioning Industry within the construction industry. In the late 1990's it was determined that previously approved construction techniques, materials, engineering and inspection used in the cement grouting of hollow ducts used in the post-tension industry were substandard. These ducts are used to carry post-tensioned steel reinforcing strand from one end of a concrete structure to the other providing active reinforcement to the concrete. Such structures include bridges, buildings and tanks. After the installation of the post-tensioning strand is completed, the ducts are filled with a fluid cementitious grout to provide structural capacity and more importantly, corrosion protection for this reinforcing steel.

Routine inspection of bridges, particularly in Florida, uncovered substantial corrosion related defects and failures of the reinforcing steel. This steel is active reinforcement, under many thousands of pounds of force and literally holds the bridge together. Failure of this steel can result in catastrophic collapse. Further in-depth investigation by numerous state Departments of Transportation and independent engineering firms have uncovered widespread problems throughout the post-tensioned bridge construction industry

Examples of these structures include:
Sunshine Skyway Bridge, Tampa, Fla.
Central Artery, Boston, Mass.
Airport Parking Garage, Raleigh Durham, N.C.
Mid-Bay Bridge, Pensacola, Fla.

To understand the problem in basic terms, the cementitious grout materials used to fill the ducts bled (separated into cement and water) and shrank creating voids in the ducts and behind the anchorages for the post-tensioned steel. It is in these areas that corrosion can occur. Major structural damage caused by corrosion has been uncovered.

As part of an ongoing industry process, inspections are being conducted by many, if not all, state Departments of Transportation of these structures. Repairs are being instituted.

As part of the repair process, it is necessary to quantify the volume of the voids, both in the ducts and behind the anchorages. It is necessary to understand that many of these voids cannot be visually inspected or opened. The repairs must be conducted ‘in the blind’. Thus it is necessary to quantify the extent of the problem using external testing equipment. Often, the only access to the voids is through a small (½ inch diameter-typical) hole, making visual inspection and conventional repair nearly impossible.

Much of the post-tensioning technology comes from Europe (France, Germany and Switzerland). The three major manufacturers of this equipment in the United States have ties to their European counterparts.

The equipment use by the European construction community to determine the volume in voids is a mechanical, analog air measuring device first designed in the 1970's-1980's. The equipment in use today was built at that time.

Additional uses of this electronic volume measuring equipment include identifying unused volume in partially filled fuel tanks or chemical containers, pressure vessels, sealed piping systems, and other air tight systems. The need arose to have modern electronic equipment; easier to use, smaller and more efficient. This has been invented by Guy Dickes, Baltimore, Md. USA.

### BRIEF SUMMARY of the INVENTION

Electronic Volume Measuring Equipment utilizes electronic gas mass flow technology in a manner to provide accurate volume measurement of air tight containers, voids in concrete, other air tight structures and piping systems and tanks. There are three variations of the process.

The first process involves pumping air (or other pressurized gas) through the device into the void or container.

The second involves evacuating air from the void or container and allowing air to rash back into the void through the device to measure volume.

The third involves evacuating air from the void or container through, the device to measure volume.

The advantages of the Electronic Volume Measuring Equipment include portability and accuracy; one version fits into a 26 inch by 10 inch by 10 inch tool box. Another version fits within a 20 inch by 10 inch by 8 inch NEMA4 electrical box. Accuracy is approximately 99%. In contrast, the European mechanical version weighs several hundred pounds, requires a rolling platform for support and its accuracy is suspect. There are no other known means of determining blind volumes.

Other advantages include ease of use and speed of results. The connection of the device to the void or container is via a small diameter (typically ⅜ inch or 1/7 inch) hose 11. Direct reading of the volume is attained from the digital output meter 9. The European equipment requires 1 inch hose and requires interpretation of an analog gauge and needles and scales.

Other uses include measuring barrels and casks, fuel tanks, storage containers, piping systems. Inert gases may be used in lieu of air for fuel tanks or other pressure vessels containing explosive or hazardous materials.

### BRIEF DESCRIPTION OF THE SEVERAL VIEWS OF THE DRAWING

The drawings attach reflect the three current versions of the Electronic Volume Measuring Equipment.

Drawing 1: Basic Equipment Lay-Out and Usage (Pressure Version)
Step 1A—Void or container at ambient pressure
Step 1B—Void or container at partial pressure
Step 1C—Void or container at full pressure

Drawing 2: Process One: Specific Internal Component Layout (Pressure Version using Compressor)

Drawing 3: Process One: Specific Internal Component Layout (Pressure Version using Compressed Gas)

Drawing 4: Process Two: Basic Equipment Lay-Out and Usage (Air Rushing Through Device into Evacuated Void or Container)
Step 4A—Void or container fully evacuated
Step 4B—Void or container at ambient pressure

Drawing 5: Process Two: Specific Internal Component Layout (Air Rushing Through Device into Evacuated Void or Container)

Drawing 6: Process Three: Basic Equipment Lay-Out and Usage (Vacuuum Drawn through Device)

Drawing 7; Process Three: Specific Internal Component Layout (Vacuum Drawn through Device)

### DETAILED DESCRIPTION of the INVENTION

The Electronic Volume Measuring Equipment utilizes commercially available electronics and mechanical components in a manner different than the purpose for which that equipment was originally designed.

There are three primary components and numerous secondary support components of this equipment. The primary components are the gas mass flow sensor 8, the digital read-out meter 9 and the pressure regulator 6. The remaining components provide protection of the equipment and controlled flow through the apparatus.

The primary equipment includes an electronic gas mass flow sensor 8 that measures the mass of a gas passing through it. It is designed to measure gas flow rate rather than volume. This mass flow meter is connected electronically to a ‘totalizer’ digital read-out meter 9, to provide total gas mass, rather than gas flow rate. The pressure regulator provides accurate control of the air mass pressure. This equipment is typically used in an industrial or laboratory environment to measure gas volume.

By utilizing this equipment, and regulating pressure, volume determinations can be made of an air tight container or void. ‘Boyle's Law’, discussed later, is the principal physical law in operation.

Major Parts, Description and Usage

Air Intake Filter 1 pleated paper type air filter to remove particulate dust (secondary)
Compressor 2: electric or hydraulic powered air device to compress air or other gas to pressures greater than 1 atmosphere greater than ambient pressure (secondary)
Condensate Filter 3: device used to remove condensed moisture from compressed air (secondary)
Desiccant Filter 4: device using silica gel or similar material to further remove moisture from the compressed air (secondary)
Particulate Filter 5: filter designed to remove fine dust created by desiccant filter from the air (secondary)
Pressure Regulator 6: high accuracy device designed to provide controlled, constant air or gas pressure to the system (primary)
Flow Controller 7: needle valve assembly or similar metering device used to restrict air flow through the gas mass flow sensor to its design rating (secondary)
Mass Flow Sensor 8: electronic device designed to measure the mass of gas flowing through and transmitting this information using a variety of outputs to the digital read-out meter 9 (primary)
Digital Read-out Meter 9: electronic device that accepts output from the mass flow sensor 8 and totalizes flow readings into total volume and presents that information through a digital read-out display primary)
Vacuum Pump 10: electric or hydraulic device designed to reduce pressure in a void or container to near perfect zero pressure conditions (secondary).
Hose 11: device to connect Electronic Volume Measuring Equipment to the entrance valve 12 (secondary)
Entrance Valve 12: Device used to physically connect to the void or container to be measured 13 (secondary)
Void or Container 13: That vessel that requires volume measurement
Compressed Gas Cylinder 14: Vessel used to provide pressurized gas in lieu of air compressor 2 (secondary)
   Process One: Pressurizing the Void or Container 13 using Compressor 2 or Compressed Gas 14:

Tile layout of components and sequence of operations is as follows:

Intake air filter 1>Compressor 2>Condensate Filter 3>Desiccant Filter 4>Particulate Filter 5>Pressure Regulator 6>Flow Controller 7>Mass Flow Sensor 8/Digital Read-out Meter 9>Hose 11,>Entrance Valve 12>Void/Container 13

Alternate-Using Compressed Gas:

Compressed Gas Cylinder 14>Pressure Regulator 6>Flow Controller 7>Mass Flow Sensor S/Digital Read-out Meter 9>Hose 11>Entrance Valve 12>Void/Container 13

Air is drawn through the intake air filter 1 by the Compressor 2. This compressed air goes through the condensate filter 3 to remove excess moisture. The compressed air continues through the desiccant filter 4 to further remove moisture. The compressed air passes through the Particulate Filter 5 to remove any dust or desiccant particles. The compressed air is then reduced in pressure to one atmosphere (14.7 psi) by the pressure regulator 6. This is the first step to providing accurate volume measurement. The controlled pressure air then goes through a flow controller 7 to match it with the capacity of the mass flow sensor 8. Finally, the air goes through the mass flow sensor 8 and into the void or sealed container 13.

The air is dried to improve accuracy through the mass flow sensor 8. The mass flow sensor 8 typically uses a 4-20 mA or voltage outputs to provide an electronic signal to the digital read-out meter 9. The digital read-out meter 9 is calibrated to the mass flow sensor 8.

One atmosphere pressure (14.7 psi, 29.92 inches of Mercury, 760 torr. 1013 millibar) is used for simplicity. Direct reading of the air mass volume from the electronic digital meter 9 is possible without calculation. Essentially, one ‘volume’ of air is going into void or container

Added commercial benefits of Process One is that leakage in the void or container can be identified using a solution of water and common household liquid soap applied manually or through spray apparatus. Leakage can also be identified audibly. An auxiliary port is provided to bypass the mass flow sensor 8/digital read-out meter 9 for this purpose.

Process Two: Allowing Air to Rush into the Evacuated Void or Container

The layout of components and sequence of operations is as follows:

Intake air filter 1>Desiccant Filter 4>Particulate Filter 5>Flow Controller 7>Mass Flow Sensor 8/Digital Read-out Meter 9>Hose 11>Entrance Valve 12>Void/Container 13

In Process Two, the void is evacuated using a high vacuum pump 10. After the void is evacuated, the entrance valve 12 is opened, allowing air to flow through the apparatus as in Process One. Air at sea level is at 14.7 psi, providing nearly the same level of accuracy as with Process One. Again the desiccant filter 4 and particulate filter 5 condition the air prior to going through the mass flow sensor 8.

Process Three: Evacuating Air through the Mass Flow Sensor 8

The layout of components and sequence of operations is as follows:

Container/Void 13>Particulate Filter 5>Flow Controller 7>Mass Flow Sensor 8/Digital Read-out Meter 9>Vacuum Pump 10

In Process Three, air in the void/container 13 is drawn through the particulate filter 5 and flow controller 7 prior to the mass flow sensor 8 and finally the vacuum pump 10.

In all of the above processes, commercially available parts are utilized. Physical connections between components are typically either brass or plastic plumbing parts.

Calibration is necessary for Process One, as accurate pressure control is required. A calibrated pressure gauge is used for establishing the one atmosphere pressure. A high accuracy pressure regulator 6 (error less than 0.1%) is used.

In all cases, the flow controller 7 is adjusted or preset to limit the gas flow through the mass flow sensor 8 to the rate set by the manufacturer. This is accomplished by measuring volume over time. If necessary, the flow controller 7 is adjusted to slow the volume of gas through the mass flow sensor S. (The sensors typically have flow rates of 5 to 200 liters per minute). The flow controller 7 is set such that the maximum flow through the mass flow sensor 8 is less than the maximum rate set by manufacturer.

The basic physical law applied is ‘Boyle's Law’ which states that:

“The volume of a fixed mass of gas varies inversely with its pressure at constant temperature”.

As an example, if we double the pressure in a given container, we have doubled the mass. Since this invention, in standard configuration, is doubling the pressure from atmospheric pressure at sea level to plus 14.7 psi, we have added one volume of gas to the container.

1-9. (canceled)

10. A device for measuring the u own empty internal volume of a closed containers void or any other air tight vessel, piping system, or tank comprising:
a remotely located regulated pressure of control gas in order to provide volumetric measurement according to Boyle's Law;

11. wherein said gas, in accordance to claim 10, may be air, elemental or molecular gas or combination of elemental or molecular gases;

12. wherein the regulated pressure of said gas may be varied to adjust for varying environmental and physical conditions;
a remotely located regulated flow controlling device to maintain accuracy of said gas through the gas mass flow sensor;

13. wherein said device may be fixed or variable;
a remotely located electronic gas mass flow sensor for providing gas volume measurement into the said void;
a remotely located digital read-out meter capable of interpreting the taw signal provided by the gas mass flow meter providing direct volume measurement of the said void, closed container or other airtight vessel;
whereas the combination of remotely located internal components measures the volume of said closed container, void or any other air tight vessel, piping system, or tank.

14. A device for measuring the unknown empty internal volume of a closed container, void or any other air tight vessel, piping system, or tank comprising:
a vacuum pump to remove (evacuate) the air from the void, container, piping system or other airtight container;

15. wherein evacuation may be complete (29.92 in HG) or may be partial vacuum a regulated flow controlling device to maintain accuracy of said gas mass flow sensor;

16. wherein said device may be fixed or variable;
a remotely located electronic gas mass flow sensor for providing gas volume measurement from said void;
a digital read-out meter capable of interpreting the raw signal provided by the gas mass flow meter providing direct volume measurement of the said void;
whereas the combination of remotely located internal components measures the volume of said closed container, void or any other air tight vessel, piping system, or tank.
